(19) United States
(12) Patent Application Publication
(10) Pub. No.: US 2012/0230446 A1
(43) Pub. Date: Sep. 13, 2012

(54) Method and Apparatus for Incorporating a WirelessHART-Enabled Device into a Wired HART Network

(76) Inventor: Xiang Feng, Bellevue, WA (US)

(21) Appl. No.: 13/413,851

(22) Filed: Mar. 7, 2012

Related U.S. Application Data
(60) Provisional application No. 61/452,022, filed on Mar. 11, 2011.

(51) Int. Cl. G06F 15/16; G06F 15/173; H04L 27/10

(52) U.S. Cl. 375/272; 709/227; 709/228; 709/224

(57) ABSTRACT

Various embodiments of the present disclosure relate to incorporating a WirelessHART-enabled device into a Wired HART network. In one aspect, a method establishes communications with a WirelessHART-enabled first device based on the WirelessHART protocol. The method then enables communications between the first device and a master device of a first Wired HART network based on the Wired HART protocol. In another aspect, an adaptor device comprises a first communications unit that transmits and receives data based on the WirelessHART protocol, a second communications unit that transmits and receives data based on the Wired HART protocol, a memory unit that stores a set of executable instructions, and a processor coupled to the first communications unit, the second communications unit, and the memory unit. Upon executing the set of executable instructions, the processor controls operations of the first communications unit and the second communications unit.

### CROSS-REFERENCE TO RELATED APPLICATIONS

This application claims the priority benefit of U.S. Patent Application Ser. No. 61/452,022, filed on Mar. 11, 2011, the entirety of which is incorporated herein by reference.

### BACKGROUND

1. Technical Field

Various embodiments of the present disclosure relate to networking and, more particularly, to method and apparatus of connecting Wireless Highway Addressable Remote Transducer (WirelessHART)-based devices to a Wired Highway Addressable Remote Transducer (Wired HART) network.

2. Description of the Relevant Art

The Wired Highway Addressable Remote Transducer (Wired HART) protocol is a backward-compatible enhancement to 4-20 mA instrumentation that allows two-way communications with smart, microprocessor-based field devices. More specifically, the Wired HART protocol is a digital industrial automation protocol that makes use of the Bell 202 Frequency-Shift Keying (FSK) standard to superimpose digital communications signals at a low level on top of the 4-20 mA signals for communications over legacy 4-20 mA analog instrumentation wiring. Communications based on the Wired HART protocol occurs between any two Wired HART-enabled devices, typically a smart field device and a control or monitoring system. Communications occurs using standard instrumentation grade wire and using standard wiring and termination practices. As the Wired HART protocol is a master/slave protocol, a smart field device (i.e., the slave) only speaks when spoken to by a master device application (i.e., the master). A number of tasks can be achieved when a master device communicates with smart field devices, including: device configuration or re-configuration, device diagnostics, device troubleshooting, reading additional measurement values, obtaining device health and status, and so on.

The Wired HART protocol provides two simultaneous communications channels: the 4-20 mA analog signal and a digital signal. The 4-20 mA signal is used for communications of the primary measured value by field smart devices using the 4-20 mA current loop. The digital signal, superimposed on the 4-20 mA analog signal, contains information from the smart field device including device status, diagnostics, additional measured or calculated values, etc.

The WirelessHART protocol is a wireless mesh network communications protocol for process automation applications, and adds wireless capabilities to the Wired HART protocol while maintaining compatibility with existing Wired HART-enabled devices, commands and tools. A WirelessHART network uses IEEE 802.15.4 compatible radios operating in the 2.4 GHz radio band. Each device in the WirelessHART mesh network can serve as a router for messages from other devices. In other words, a device does not have to communicate directly to a gateway, but just forward its message to the next closest devices. This extends the range of the WirelessHART network and provides redundant communications routes to increase reliability.

Under current technology, a Wired HART field instrument may become a part of a WirelessHART network when the field instrument is fitted with and connected to the WirelessHART network through a WirelessHART adaptor. Accordingly, once enabled by a WirelessHART adaptor, field instruments of a Wired HART network can join a WirelessHART network. This allows the WirelessHART network to expand to provide a cost-effective communications solution. However, presently there is no provision for a WirelessHART-enabled device that is not already connected to a Wired HART network to join and become a part of an existing Wired HART network.

### SUMMARY

Various embodiments of the present disclosure are directed to techniques of incorporating one or more WirelessHART-enabled devices into a Wired HART network.

In one aspect, a method may comprise: establishing communications with a WirelessHART-enabled first device based on the WirelessHART protocol; and enabling communications between the first device and a master device of a first Wired HART network based on the Wired HART protocol.

The communications established with the master device of the first Wired HART network may be based on a 4-20 mA analog channel, the Frequency-Shift Keying (FSK) HART protocol, or both.

Enabling communications between the first device and the master device of the first Wired HART network based on the Wired HART protocol may comprise enabling communications between the first device and the master device of the first Wired HART network such that the master device of the first Wired HART network treats the first device as a Wired HART-enabled device that is a part of the first Wired HART network.

The method may further comprise: receiving data on one or more parameters from the first device based on the WirelessHART protocol; and transmitting the data on the one or more parameters received from the first device to the master device of the first Wired HART network based on the Wired HART protocol.

The method may further comprise: receiving at least one command directed to the first device from the master device of the first Wired HART network based on the Wired HART protocol; and transmitting the at least one command to the first device based on the WirelessHART protocol.

The at least one command received from the master device of the first Wired HART network may be related to at least one of the following: device configuration or re-configuration, device diagnostics, device troubleshooting, reading additional measurement values, and obtaining device status.

In an event that the received at least one command relates to collecting digital sensor data and that the first Wired HART network consists of the master device and an adaptor that enables the communications between the first device and the master device, the method may further comprise converting the digital sensor data into analog data for transmission on the first Wired HART network. The master device may comprise an analog signal input device that is not a HART protocol-based master device.

The method may further comprise: establishing communications with one or more second WirelessHART-enabled devices; and enabling communications between the one or more second WirelessHART-enabled devices and the master device of the first Wired HART network based on the Wired HART protocol.

The method may further comprise: serving as a network manager, a gateway, and an access point for the first device and the one or more second WirelessHART-enabled devices.

In another aspect, a method may comprise: establishing communications with a WirelessHART-enabled first device based on the WirelessHART protocol; receiving at least one command directed to the first device from a master device of a first Wired HART network based on the Wired HART protocol; and transmitting the at least one command to the first device based on the WirelessHART protocol.

The method may further comprise: establishing communications with the master device of the first Wired HART network based on a 4-20 mA analog channel, the Frequency-Shift Keying (FSK) HART protocol, or both.

The method may further comprise: establishing communications with one or more second WirelessHART-enabled devices; receiving data on one or more parameters from at least one of the one or more second WirelessHART-enabled devices; and transmitting the data on the one or more parameters received from the at least one of the one or more second WirelessHART-enabled devices to the master device of the first Wired HART network based on the Wired HART protocol.

The method may further comprise: configuring a first WirelessHART network that includes the first device and the one or more second WirelessHART-enabled devices; scheduling communications among the first device and the one or more second WirelessHART-enabled devices; managing routes of data transmitted by the first device and the one or more second WirelessHART-enabled devices; and monitoring network health of the first WirelessHART network. The master device of the first Wired HART network treats each device of the first WirelessHART network as a Wired HART-enabled device that is a part of the first Wired HART network.

In yet another aspect, an adaptor device may comprise: a first communications unit that transmits and receives data based on the WirelessHART protocol; a second communications unit that transmits and receives data based on the Wired HART protocol; a memory unit that stores a set of executable instructions; and a processor coupled to the first communications unit, the second communications unit, and the memory unit, the processor configured to control operations of the first communications unit and the second communications unit upon executing the set of executable instructions.

The processor may be further configured to: establish communication, via the first communications unit, with a WirelessHART-enabled first device based on the WirelessHART protocol; and establish communication, via the second communications unit, with a master device of a first Wired HART network based on the Wired HART protocol.

The processor may be further configured to: receive, via the first communications unit, data on one or more parameters from the first device based on the WirelessHART protocol; and transmit, via the second communications unit, the data on the one or more parameters received from the first device to the master device of the first Wired HART network based on the Wired HART protocol.

The processor may be further configured to include the data on one or more parameters from the first device in a message to the master device of the first Wired HART network from a second device that is a part of the first Wired HART network, the message further including data on one or more parameters from the second device.

The processor may be further configured to: receive, via the first communications unit, from the master device of the first Wired HART network at least one command directed to the first device based on the Wired HART protocol; and transmit, via the second communications unit, the at least one command to the first device based on the WirelessHART protocol.

The at least one command received from the master device of the first Wired HART network may be related to at least one of the following: device configuration or re-configuration, device diagnostics, device troubleshooting, reading additional measurement values, and obtaining device status.

The processor may be further configured to: establish communication, via the first communications unit, with one or more second WirelessHART-enabled devices; receive, via the first communications unit, data on one or more parameters from at least one of the one or more second WirelessHART-enabled devices; and transmit, via the second communications unit, the data on the one or more parameters received from the at least one of the one or more second WirelessHART-enabled devices to the master device of the first Wired HART network based on the Wired HART protocol.

The processor may be further configured to: configure a first WirelessHART network that includes the first device and the one or more second WirelessHART-enabled devices; schedule communications among the first device and the one or more second WirelessHART-enabled devices; manage routes of data transmitted by the first device and the one or more second WirelessHART-enabled devices; and monitor network health of the first WirelessHART network.

The second communications unit may be further configured to establish communications with a Foundation Fieldbus network, a Process Field Bus (PROFIBUS) network, or both.

The first communications unit may be further configured to establish communications with another wireless network for industrial automation, the another wireless network comprising an ISA100 network, a Wireless Networks for Industrial Automation-Process Automation (WIA-PA) network, or a combination thereof.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram of a first scheme in accordance with an embodiment to the present disclosure.

FIG. 2 is a diagram of a second scheme in accordance with an embodiment to the present disclosure.

FIG. 3 is a flowchart of a first method in accordance with an embodiment to the present disclosure.

FIG. 4 is a flowchart of a second method in accordance with an embodiment to the present disclosure.

FIG. 5 is a block diagram of an adaptor device in accordance with an embodiment to the present disclosure.

### DETAILED DESCRIPTION

### Overview

Various embodiments of the present disclosure pertain to incorporating one or more WirelessHART-enabled devices into an existing Wired HART network. One or more of the slave devices of the Wired HART network may each be equipped with an adaptor device. The adaptor device is configured to communicate with the respective slave device and the master device of the Wired HART network via the Wired HART protocol. The adaptor device is further configured to communicate with one or more WirelessHART-enabled devices via the WirelessHART protocol to relay messages from the one or more WirelessHART-enabled devices to the master device of the Wired HART network, and relay commands from the master device of the Wired HART network to the one or more WirelessHART-enabled devices. That is, the adaptor device functions as a WirelessHART gateway for the one or more WirelessHART-enabled devices.

When relaying messages from the one or more WirelessHART-enabled devices to the master device of the Wired HART network, the adaptor device may render the one or more WirelessHART-enabled devices to appear as one or more additional Wired HART-enabled devices tapped to the wiring, thus appearing as one or more additional Wired HART-enabled devices in the Wired HART network from the perspective of the master device of the Wired HART network. This allows a non-intrusive incorporation of the one or more WirelessHART-enabled devices into the Wired HART network.

When the adaptor device is in communicative connection with one or more WirelessHART-enabled device, the adaptor device also functions as a WirelessHART network manager, gateway, and access point with respect to the one or more WirelessHART-enabled devices.

When a WirelessHART-enabled device is not in communicative connection with a WirelessHART network, such as when the WirelessHART-enabled device is deployed in a location with no existing WirelessHART network, data on one or more parameters collected by such WirelessHART-enabled devices cannot be monitored or utilized. Thus, with one or more slave devices of a Wired HART network equipped with the adaptor device of the present disclosure, one or more WirelessHART-enabled devices not currently connected to a WirelessHART network may be communicatively coupled to the Wired HART network to provide data on the measured one or more parameters.

### Illustrative Schemes

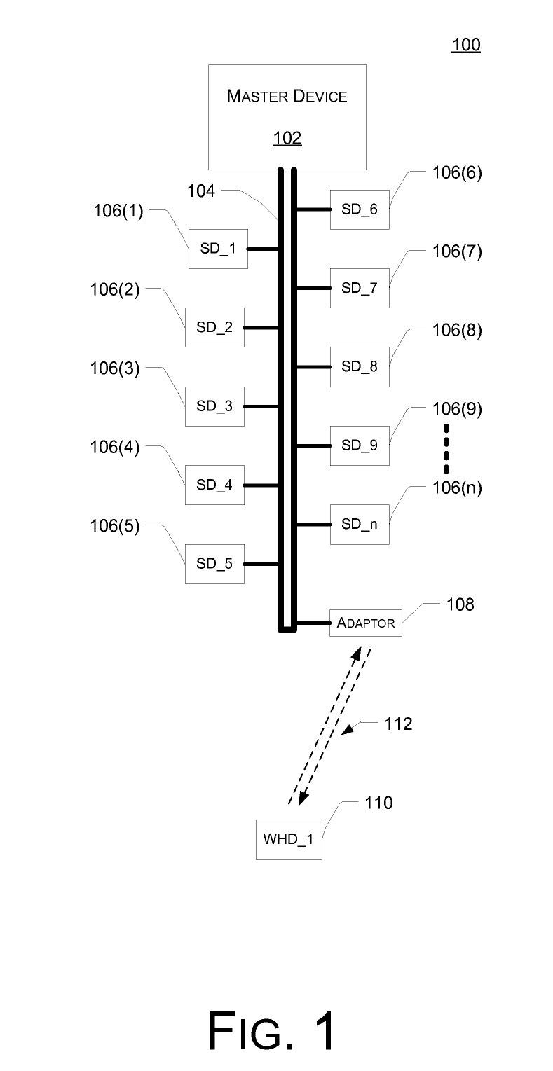

FIG. 1 illustrates a scheme involving a Wired HART network 100 in accordance with an embodiment to the present disclosure.

The Wired HART network 100 includes a master device 102, wiring 104, and a plurality of slave devices 106(1)-106(n). The wiring 104 may be twisted pair wiring or any pertinent wiring or cabling that constitutes the 4-20 mA current loop in a typical Wired HART network. Although a fixed quantity of slave devices are shown in FIG. 1, the quantity of slave devices may be more or less than that shown in FIG. 1 in various embodiments in accordance with the present disclosure. The master device 102 receives messages, including 4-20 mA analog signals and digital signals, from the plurality of slave devices 106(1)-106(n) and transmits commands to the plurality of slave devices 106(1)-106(n) based on the Wired HART protocol. As the Wired HART protocol permits dual master devices in a Wired HART network, the master device 102 of the Wired HART network 100 may be the primary master device or the secondary master device, while the other master device is not shown in FIG. 1.

An adaptor device 108 is installed on, attached to, or otherwise communicatively coupled to the wiring 104 of the Wired HART network 100 in accordance with an embodiment of the present disclosure. With the adaptor device 108 installed on, attached to, or otherwise communicatively coupled to the wiring 104 so as to equip the Wired HART network 100 with the adaptor device 108, one or more WirelessHART-enabled devices will be able to establish communications based on the WirelessHART protocol with the master device 102 and thus be incorporated as part of the HART network 100. The adaptor device 108, in such case, would function as a WirelessHART network manager, gateway, and access point for the one or more WirelessHART-enabled devices with which the adaptor device 108 has established communications based on the WirelessHART protocol.

In one embodiment, communications between the adaptor device 108 and the master device 102 of the Wired HART network 100 is based on 4-20 mA analog channel. In another embodiment, communications between the adaptor device 108 and the master device 102 is based on the Frequency-Shift Keying (FSK) HART protocol. Alternatively, communications between the adaptor device 108 and the master device 102 is based on both the 4-20 mA analog channel and the FSK HART protocol. In the case of 4-20 mA analog channel, the adaptor device 108 can translate the primary variable from the WirelessHART-enabled device communicatively coupled to the adaptor device 108 into a current signal, in the 4-20 mA range, to the FSK HART network which the network 100 may be. A FSK HART network only allows up to one active current transmitter. In such case, the Wired HART network 100 may include one slave device 106 where n=1.

In one embodiment, there may be only one device on the 4-20 mA analog channel and wire-connected to the master device 102. When the adaptor device 108 converts the digital process value from the WirelessHART-enabled device into analog signal on the 4-20 mA cable, the master device 102 needs not be a HART protocol-based master device but may be any master device that can read the analog signal on the 4-20 mA analog channel.

As shown in FIG. 1, a WirelessHART-enabled device 110 is within a wireless communications range to be communicatively coupled to the adaptor device 108. The WirelessHART-enabled device 110 may be a field instrumentation measuring one or more parameters. The WirelessHART-enabled device 110 may or may not previously be a part of a WirelessHART network. As an example, the WirelessHART-enabled device 110 may originally be a part of a WirelessHART network and providing data on the one or more measured parameters. For whatever reason, the WirelessHART-enabled device 110 is now disconnected from that WirelessHART network, whether temporarily or permanently. As another example, the WirelessHART-enabled device 110 may be a newly commissioned field instrumentation to measure one or more parameters at a location where no existing WirelessHART network is in place. In any event, during a period of time as illustrated in FIG. 1, the WirelessHART-enabled device 110 is not a part of any existing WirelessHART network.

In one embodiment, upon detecting the presence of a WirelessHART-enabled device 110, the adaptor device 108 can establish communications with the WirelessHART-enabled device 110 via wireless signal 112 based on the WirelessHART protocol. The adaptor device 108 can further establish communications with the master device 102 based on the Wired HART protocol.

Once the communications with the WirelessHART-enabled device 110 has been established, the adaptor device 108 may receive from the WirelessHART-enabled device 110 data on one or more parameters measured or otherwise monitored by the WirelessHART-enabled device 110, based on the WirelessHART protocol. Additionally, the adaptor device 108 may transmit the data received from the WirelessHART-enabled device 110 to the master device 102 in messages based on the Wired HART protocol via the wiring 104.

In one embodiment, once the WirelessHART-enabled device 110 is communicatively coupled to the adaptor device 108, one or more messages transmitted by the slave device 106(n) may include the data on the one or more parameters received from the WirelessHART-enabled device 110.

In one embodiment, the adaptor device 108 may receive at least one command directed to the WirelessHART-enabled device 110 from the master device 102 and transmit the received at least one command to the WirelessHART-enabled device 110. The at least one command received from the master device 102 may be related to at least one of the following: device configuration or re-configuration, device diagnostics, device troubleshooting, reading additional measurement values, and obtaining device status.

In an event that the received at least one command relates to collecting digital sensor data and that the Wired HART network 100 consists of the master device 102 and the adaptor device 108 that enables the communications between the WirelessHART-enabled device 110 and the master device 102, the adaptor device 108 may convert the digital sensor data into analog data for transmission on the Wired HART network 100. In this case, the master device 102 may comprise an analog signal input device that is not a HART protocol-based master device.

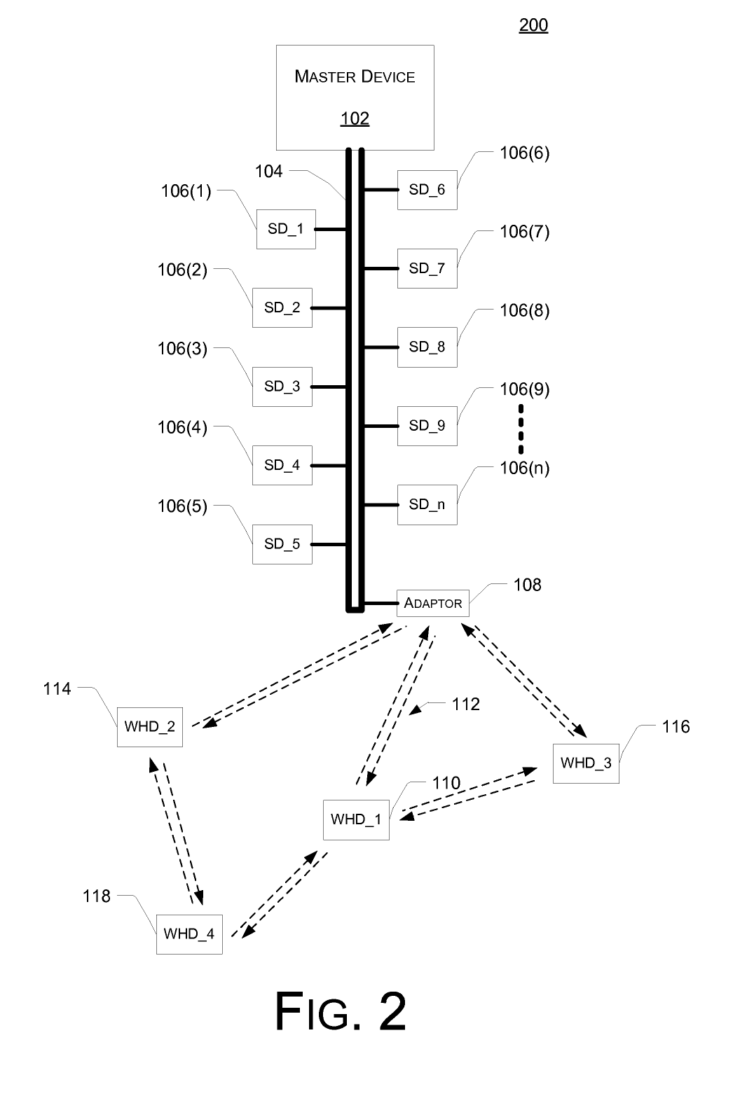

FIG. 2 illustrates another scheme involving a Wired HART network 200 in accordance with an embodiment to the present disclosure.

The Wired HART network 200 is similar to the Wired HART network 100 in that the Wired HART network 200 also includes the master device 102, the wiring 104, and the plurality of slave devices 106(1)-106(n). The Wired HART network 200 is also equipped with the adaptor device 108 as described above. What is different, however, is that in the scheme illustrated in FIG. 2 there are more than one WirelessHART-enabled devices communicatively coupled to the adaptor device 108, namely the WirelessHART-enabled devices 110, 114 and 116. There may also be one or more additional WirelessHART-enabled devices, such as the WirelessHART-enabled device 118, that are not directly but indirectly in communicative connection with the adaptor device 108 through other WirelessHART-enabled devices that are communicatively coupled with the adaptor device 108 directly.

As shown in FIG. 2, a WirelessHART network may be formed among the adaptor device 108, functioning as a WirelessHART access point as well as a gateway, and the WirelessHART-enabled devices 110, 114, 116 and 118. Although a fixed number of WirelessHART-enabled devices are shown in FIG. 2 for illustrative purpose only, in actual implementation of the various embodiments of the present disclosure there may be more or fewer WirelessHART-enabled devices than those shown in FIG. 2. Within this WirelessHART network, the WirelessHART-enabled devices 110, 114, 116 and 118 may communicate among themselves according to the WirelessHART protocol. For example only and as illustrated in FIG. 2, the WirelessHART-enabled device 110 may be in direct communications connection with the adaptor device 108, the WirelessHART-enabled device 116, and the WirelessHART-enabled device 118; the WirelessHART-enabled device 114 may be in direct communications connection with the adaptor device 108 and the WirelessHART-enabled device 118; the WirelessHART-enabled device 116 may be in direct communications connection with the adaptor device 108 and the WirelessHART-enabled device 110; and the WirelessHART-enabled device 118 may be in direct communications connection with the WirelessHART-enabled device 110 and the WirelessHART-enabled device 114.

In one embodiment, the adaptor device 108 may establish communications with the WirelessHART-enabled devices 110, 114 and 116, and receive respective data on one or more parameters from each or at least one of the WirelessHART-enabled devices 110, 114 and 116. Given that the WirelessHART-enabled device 118 is part of the WirelessHART network, the adaptor device 108 may also receive respective data on one or more parameters from the WirelessHART-enabled device 118 via one of the WirelessHART-enabled devices 110, 114 and 116. Upon receiving the data on the one or more parameters from each, some or at least one of the WirelessHART-enabled devices 110, 114, 116 and 118, the adaptor device 108 may transmit the received data to the master device 102 for further processing.

In one embodiment, in addition to functioning as an access point and a gateway, the adaptor device 108 may function as a WirelessHART network manager and perform some or all the tasks a typical WirelessHART network manager would do with respect to the WirelessHART network comprising the WirelessHART-enabled devices 110, 114, 116 and 118. For example, the adaptor device 108 may configure the WirelessHART network, schedule communications among the WirelessHART-enabled devices 110, 114, 116 and 118, manage routes of data transmitted by the WirelessHART-enabled devices 110, 114, 116 and 118, and monitor network health of the WirelessHART network comprising the WirelessHART-enabled devices 110, 114, 116 and 118.

### Illustrative Operations

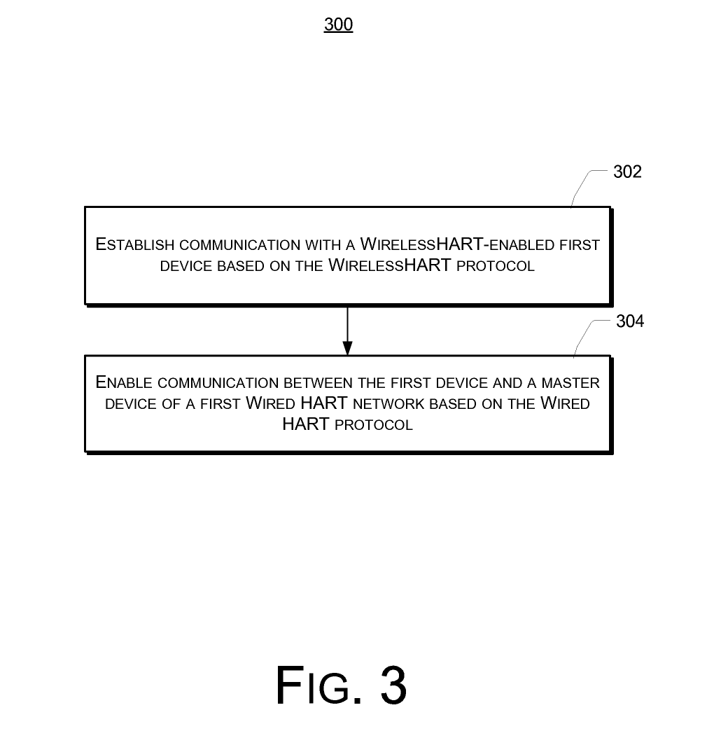

FIG. 3 illustrates a flowchart of a first method 300 in accordance with an embodiment to the present disclosure.

At 302, upon detecting a presence of a WirelessHART-enabled first device, the method 300 establishes communications with the WirelessHART-enabled first device based on the WirelessHART protocol. For example, referring to FIG. 1, upon detecting the presence of the WirelessHART-enabled device 110, the adaptor device 108 establishes communications with the WirelessHART-enabled device 110 based on the WirelessHART protocol.

At 304, the method 300 enables communications between the first device and a master device of a first Wired HART network based on the Wired HART protocol. Using the previous example, once the communications with the WirelessHART-enabled device 110 has been established, the adaptor device 108 enables communications between the WirelessHART-enabled device 110 and the master device 102 based on the Wired HART protocol.

In one embodiment, the method 300 may enable communications between the first device and the master device of the first Wired HART network such that the master device of the first Wired HART network treats the first device as a HART-enabled device that is a part of the first HART network. For example, based on the HART protocol, the adaptor device 108 may render the WirelessHART-enabled device 110 to appear as an additional Wired HART-enabled device that is tapped to the wiring 104, thus appearing as one more Wired HART-enabled device in the Wired HART network 100 from the perspective of the master device 102. Alternatively, the adaptor device 108 may embed the data from the WirelessHART-enabled device 110 to the master device 102 in messages transmitted from the slave device 106(n) to the master device 102 according to the Wired HART protocol.

In one embodiment, the method 300 may further receive data on one or more parameters from the first device based on the WirelessHART protocol, and transmit the data on the one or more parameters received from the first device to the master device of the first Wired HART network based on the Wired HART protocol.

In one embodiment, the method 300 may further receive at least one command directed to the first device from the master device of the first Wired HART network based on the Wired HART protocol, and transmit the at least one command to the first device based on the WirelessHART protocol. The at least one command received from the master device of the first Wired HART network may be related to at least one of the following: device configuration or re-configuration, device diagnostics, device troubleshooting, reading additional measurement values, and obtaining device status.

In one embodiment, the method 300 may further establish communications with one or more second WirelessHART-enabled devices, and enable communications between the one or more second WirelessHART-enabled devices and the master device of the first Wired HART network based on the Wired HART protocol. For example, referring to FIG. 2, upon detecting a presence of either or both of the WirelessHART-enabled device 114 and 116, the adaptor device 108 establishes communications with the WirelessHART-enabled device 114 and/or 116, and enables communications between the WirelessHART-enabled device 114 and/or 116 with the master device 102. Although the WirelessHART-enabled device 118 may not be directly in communicative connection with the adaptor device 108, communications between the adaptor device 108 and the WirelessHART-enabled device 118 may still be established based on the WirelessHART protocol. Consequently, communications between the WirelessHART-enabled device 118 and the master device 102 of the Wired HART network 200 may be enabled by way of the adaptor device 108.

In one embodiment, the method 300 may further network manage the first device and the one or more second WirelessHART-enabled devices. For example, as described above, the adaptor device 108 may function as a WirelessHART network manager and perform some or all the tasks a typical WirelessHART network manager would do with respect to the WirelessHART network comprising the WirelessHART-enabled devices 110, 114, 116 and 118. For instance, the adaptor device 108 may configure the WirelessHART network, schedule communications among the WirelessHART-enabled devices 110, 114, 116 and 118, manage routes of data transmitted by the WirelessHART-enabled devices 110, 114, 116 and 118, and monitor network health of the WirelessHART network comprising the WirelessHART-enabled devices 110, 114, 116 and 118.

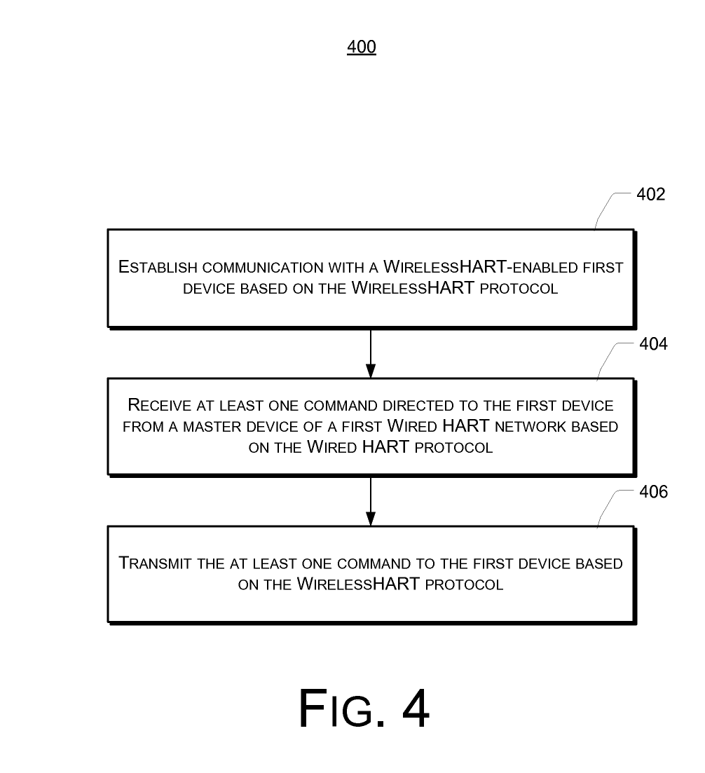

FIG. 4 illustrates a flowchart of a second method 400 in accordance with an embodiment to the present disclosure.

At 402, the method 400 establishes communications with a WirelessHART-enabled first device based on the WirelessHART protocol. For example, upon detecting the presence of the WirelessHART-enabled device 110, the adaptor device 108 establishes communications with the WirelessHART-enabled device 110 based on the WirelessHART protocol.

At 404, the method 400 receives at least one command directed to the first device from a master device of a first Wired HART network based on the Wired HART protocol. For example, after communications with the WirelessHART-enabled device 110 has been established by the adaptor device 108 such that the device 110 appears to be a Wired HART device to the master device 102, the adaptor device 108 receives from the master device 102 at least one command that is directed to the WirelessHART-enabled device 110, for example, to request for data on one or more parameters measured or otherwise monitored by the WirelessHART-enabled device 110.

At 406, the method 400 transmits the at least one command to the first device based on the WirelessHART protocol. For example, upon receiving the at least one command from the master device 102, the adaptor device 108 transmits the at least one command to the WirelessHART-enabled device 110.

The method 400 may further receive the data on the one or more parameters from the first device based on the WirelessHART protocol, and transmit the received data to the master device of the first Wired HART network based on the Wired HART protocol.

The method 400 may further establish communications with one or more second WirelessHART-enabled devices, receive data on one or more parameters from at least one of the one or more second WirelessHART-enabled devices, and transmit the data on the one or more parameters received from the at least one of the one or more second WirelessHART-enabled devices to the master device of the first HART network based on the HART protocol. For example, upon detecting a presence of either or both of the WirelessHART-enabled device 114 and 116, the adaptor device 108 establishes communications with the WirelessHART-enabled device 114 and/or 116, and enables communications between the WirelessHART-enabled device 114 and/or 116 with the master device 102. Although the WirelessHART-enabled device 118 may not be directly in communicative connection with the adaptor device 108, communications between the adaptor device 108 and the WirelessHART-enabled device 118 may still be established based on the WirelessHART protocol. Consequently, communications between the WirelessHART-enabled device 118 and the master device 102 of the HART network 200 may be enabled by way of the adaptor device 108.

The method 400 may further configure a first WirelessHART network that includes the first device and the one or more second WirelessHART-enabled devices, schedule communications among the first device and the one or more second WirelessHART-enabled devices, manage routes of data transmitted by the first device and the one or more second WirelessHART-enabled devices, and monitor network health of the first WirelessHART network. For example and as described above, the adaptor device 108 may function as a WirelessHART network manager and perform some or all the tasks a typical WirelessHART network manager would do with respect to the WirelessHART network comprising the WirelessHART-enabled devices 110, 114, 116 and 118.

### Exemplary Adaptor Device

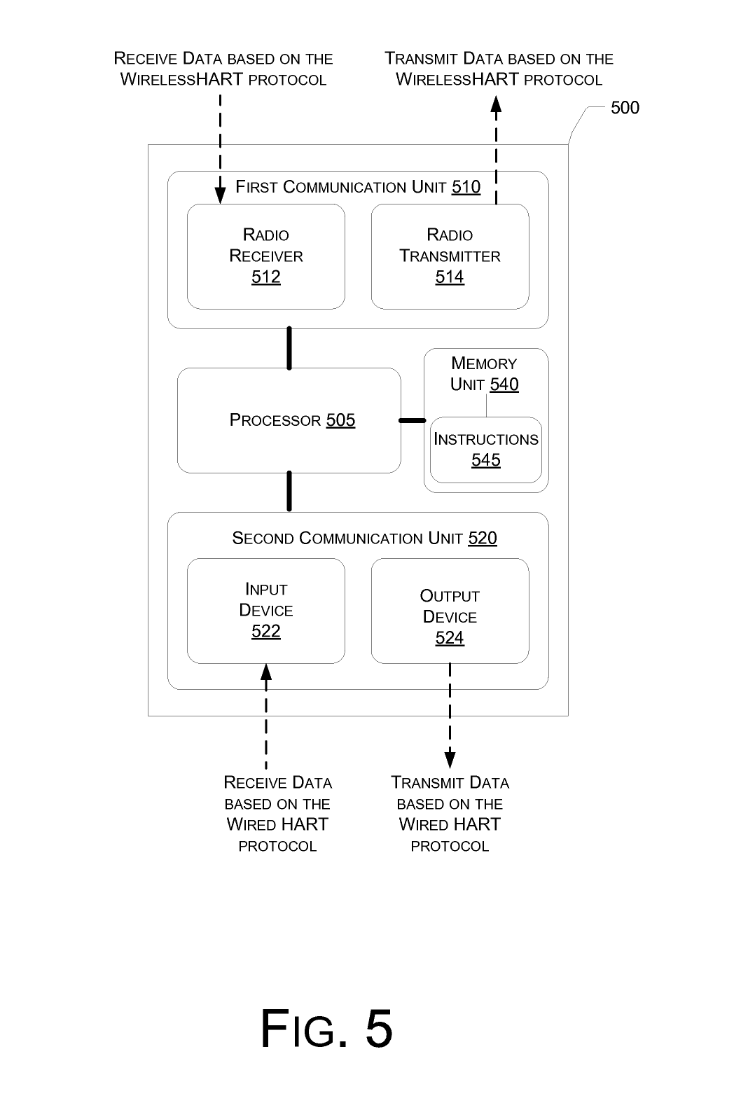

FIG. 5 illustrates a block diagram of an adaptor device 500 in accordance with an embodiment to the present disclosure.

The representative adaptor device 500 may implement the techniques for incorporating one or more WirelessHART-enabled devices to a Wired HART network. That is, the adaptor device 500 may be the adaptor device 108 in FIG. 1 and FIG. 2, and be configured to implement method 300 and method 400, and any variations thereof. However, it will be readily appreciated that the techniques disclosed herein may be implemented in other adaptor or computing devices, systems, and environments. The adaptor device 500 shown in FIG. 5 is merely one example of an adaptor device and is not intended to suggest any limitation as to the scope of use or functionality of the adaptor and network architectures.

In at least one configuration, the adaptor device 500 comprises a first communications unit 510 that transmits and receives data based on the WirelessHART protocol, a second communications unit 520 that transmits and receives data based on the Wired HART protocol, a memory unit 540 that stores a set of executable instructions 545, and a processor 505 coupled to the first communications unit 510, the second communications unit 520, and the memory unit 540. The processor 505 is configured to control operations of the first communications unit 510 and the second communications unit 520 upon executing the set of executable instructions 545.

Depending on the exact configuration and type of adaptor device, the memory 540 may be volatile (such as RAM), non-volatile (such as ROM, flash memory, etc.) or some combination thereof. In addition to the set of instructions 545, the memory 540 may further store an operating system, one or more program modules, and may include program data.

The first communications unit 510 may be a wireless communications device and comprise a radio receiver 512 and a radio transmitter 514. For example, the first communications unit 510 may be configured to receive and transmit WirelessHART-based data via the radio receiver 512 and the radio transmitter 512, respectively. The second communications unit 520 may be a wired communications device and comprise an input device 522 and an output device 524. For example, the second communications unit 520 may be configured to receive and transmit Wired HART-based data via the input device 522 and the output device 524, respectively. Alternatively or additionally, the second communications unit 520 may be further configured to establish communications with a Foundation Fieldbus network, a Process Field Bus (PROFIBUS) network, or both. This would allow the adaptor device 500 to appear as a wired device on a corresponding network.

In one embodiment, the first communications unit 510 may be further configured to establish communications with another wireless network for industrial automation, the another wireless network comprising an ISA100 network, a Wireless Networks for Industrial Automation-Process Automation (WIA-PA) network, or a combination thereof.

In one embodiment, when the adaptor device 500 is installed on, attached to, or otherwise communicatively coupled to in the wiring of a Wired HART network, such as the wiring 104 of the Wired HART network 100 or the Wired HART network 200, the second communications unit 520 may communicate with the master device of the Wired HART network.

In one embodiment, the processor 505 may be further configured to establish communication, via the first communications unit 510, with a WirelessHART-enabled first device, such as the WirelessHART-based device 110 for example, based on the WirelessHART protocol. The processor 505 may also be configured to establish communication, via the second communications unit 520, with a master device of a first Wired HART network, such as the master device 102 of the Wired HART network 100 or the master device 102 of the Wired HART network 200 for example, based on the Wired HART protocol.

In one embodiment, the processor 505 may be further configured to receive, via the first communications unit 510, data on one or more parameters from the first device based on the WirelessHART protocol, and transmit, via the second communications unit 520, the data on the one or more parameters received from the first device to the master device of the first Wired HART network based on the Wired HART protocol.

In one embodiment, the processor 505 may be further configured to include the data on one or more parameters from the first device in a message to the master device of the first Wired HART network from a second device that is a part of the first Wired HART network, the message further including data on one or more parameters from the second device.

In one embodiment, the processor 505 may be further configured to receive, via the first communications unit 510, from the master device of the first Wired HART network at least one command directed to the first device based on the Wired HART protocol, and transmit, via the second communications unit 520, the at least one command to the first device based on the WirelessHART protocol. The at least one command received from the master device of the first Wired HART network may be related to at least one of the following: device configuration or re-configuration, device diagnostics, device troubleshooting, reading additional measurement values, and obtaining device status.

In one embodiment, the processor 505 may be further configured to establish communication, via the first communications unit 510, with one or more second WirelessHART-enabled devices, receive, via the first communications unit 510, data on one or more parameters from at least one of the one or more second WirelessHART-enabled devices, and transmit, via the second communications unit 520, the data on the one or more parameters received from the at least one of the one or more second WirelessHART-enabled devices to the master device of the first Wired HART network based on the Wired HART protocol.

In one embodiment, the processor 505 may be further configured to configure a first WirelessHART network that includes the first device and the one or more second WirelessHART-enabled devices, schedule communications among the first device and the one or more second WirelessHART-enabled devices, manage routes of data transmitted by the first device and the one or more second WirelessHART-enabled devices, and monitor network health of the first WirelessHART network.

It is appreciated that the illustrated adaptor device 500 is only one example of a suitable device and is not intended to suggest any limitation as to the scope of use or functionality of the various embodiments described.

### CONCLUSION

The above-described techniques pertain to incorporating one or more WirelessHART-enabled devices into a Wired HART network. Although the techniques have been described in language specific to structural features and/or methodological acts, it is to be understood that the appended claims are not necessarily limited to the specific features or acts described. Rather, the specific features and acts are disclosed as exemplary forms of implementing such techniques. For example, the embodiments provided may be mainly directed to incorporating one or more WirelessHART-enabled devices into a Wired HART network, the techniques may be applied to incorporate one or more WirelessHART-enabled devices into a Foundation Fieldbus network, a PROFIBUS network, a Modbus network, or an Industrial Ethernet network.

All references, including publications, cited herein are hereby incorporated by reference to the same extent as if each reference were individually and specifically indicated to be incorporated by reference and were set forth in its entirety herein.

What is claimed is:

1. A method comprising:
establishing communications with a Wireless Highway Addressable Remote Transducer (WirelessHART)-enabled first device based on the WirelessHART protocol; and
enabling communications between the first device and a master device of a first Wired Highway Addressable Remote Transducer (Wired HART) network based on the Wired HART protocol.

2. The method as recited in claim 1, wherein the communications established with the master device of the first Wired HART network is based on a 4-20 mA analog channel, the Frequency-Shift Keying (FSK) HART protocol, or both.

3. The method as recited in claim 1, wherein enabling communications between the first device and the master device of the first Wired HART network based on the Wired HART protocol comprises enabling communications between the first device and the master device of the first Wired HART network such that the master device of the first HART network treats the first device as a Wired HART-enabled device that is a part of the first Wired HART network.

4. The method as recited in claim 1, further comprising:
receiving data on one or more parameters from the first device; and
transmitting the data on the one or more parameters received from the first device to the master device of the first Wired HART network.

5. The method as recited in claim 1, further comprising:
receiving at least one command directed to the first device from the master device of the first Wired HART network; and
transmitting the at least one command to the first device.

6. The method as recited in claim 5, wherein in an event that the received at least one command relates to collecting digital sensor data and that the first Wired HART network consists of the master device and an adaptor that enables the communications between the first device and the master device, the method further comprises converting the digital sensor data into analog data for transmission on the first Wired HART network.

7. The method as recited in claim 6, wherein the master device comprises an analog signal input device that is not a HART protocol-based master device.

8. The method as recited in claim 5, wherein the at least one command received from the master device of the first Wired HART network is related to at least one of the following: device configuration or re-configuration, device diagnostics, device troubleshooting, reading additional measurement values, and obtaining device status.

9. The method as recited in claim 1, further comprising:
establishing communications with one or more second WirelessHART-enabled devices; and
enabling communications between the one or more second WirelessHART-enabled devices and the master device of the first Wired HART network based on the Wired HART protocol.

10. The method as recited in claim 9, further comprising:
functioning as a network manager, a gateway, and an access point for the first device and the one or more second WirelessHART-enabled devices.

11. A method comprising:
establishing communications with a Wireless Highway Addressable Remote Transducer (WirelessHART)-enabled first device based on the WirelessHART protocol;
receiving at least one command directed to the first device from a master device of a first Wired Highway Addressable Remote Transducer (Wired HART) network based on the Wired HART protocol; and
transmitting the at least one command to the first device based on the WirelessHART protocol.

12. The method as recited in claim 11, further comprising:
establishing communications with the master device of the first Wired HART network based on a 4-20 mA analog channel, the Frequency-Shift Keying (FSK) HART protocol, or both.

13. The method as recited in claim 11, further comprising:
establishing communications with one or more second WirelessHART-enabled devices based on the WirelessHART protocol;
receiving data on one or more parameters from at least one of the one or more second WirelessHART-enabled devices; and
transmitting the data on the one or more parameters received from the at least one of the one or more second WirelessHART-enabled devices to the master device of the first Wired HART network based on the Wired HART protocol.

14. The method as recited in claim 13, further comprising:
configuring a first WirelessHART network that includes the first device and the one or more second WirelessHART-enabled devices;
scheduling communications among the first device and the one or more second WirelessHART-enabled devices;
managing routes of data transmitted by the first device and the one or more second WirelessHART-enabled devices; and
monitoring network health of the first WirelessHART network.

15. An adaptor device comprising:
a first communications unit that transmits and receives data based on the Wireless Highway Addressable Remote Transducer (WirelessHART) protocol;
a second communications unit that transmits and receives data based on the Wired Highway Addressable Remote Transducer (Wired HART) protocol;
a memory unit that stores a set of executable instructions; and
a processor coupled to the first communications unit, the second communications unit, and the memory unit, the processor configured to control operations of the first communications unit and the second communications unit upon executing the set of executable instructions.

16. The adaptor device as recited in claim 15, wherein the processor is further configured to:
establish communication, via the first communications unit, with a WirelessHART-enabled first device based on the WirelessHART protocol; and
establish communication, via the second communications unit, with a master device of a first Wired HART network based on the Wired HART protocol.

17. The adaptor device as recited in claim 16, wherein the processor is further configured to:
receive, via the first communications unit, data on one or more parameters from the first device based on the WirelessHART protocol; and
transmit, via the second communications unit, the data on the one or more parameters received from the first device to the master device of the first Wired HART network based on the Wired HART protocol.

18. The adaptor device as recited in claim 16, wherein the processor is further configured to include the data on the one or more parameters from the first device in a message to the master device of the first Wired HART network from a second device that is a part of the first Wired HART network, the message further including data on one or more parameters from the second device.

19. The adaptor device as recited in claim 16, wherein the processor is further configured to:
receive, via the first communications unit, from the master device of the first Wired HART network at least one command directed to the first device based on the Wired HART protocol; and
transmit, via the second communications unit, the at least one command to the first device based on the WirelessHART protocol.

20. The adaptor device as recited in claim 16, wherein the processor is further configured to:
establish communication, via the first communications unit, with one or more second WirelessHART-enabled devices;
receive, via the first communications unit, data on one or more parameters from at least one of the one or more second WirelessHART-enabled devices; and
transmit, via the second communications unit, the data on the one or more parameters received from the at least one of the one or more second WirelessHART-enabled devices to the master device of the first Wired HART network based on the Wired HART protocol.

21. The adaptor device as recited in claim 20, wherein the processor is further configured to:
configure a first WirelessHART network that includes the first device and the one or more second WirelessHART-enabled devices;
schedule communications among the first device and the one or more second WirelessHART-enabled devices;
manage routes of data transmitted by the first device and the one or more second WirelessHART-enabled devices; and
monitor network health of the first WirelessHART network.

22. The adaptor device as recited in claim 15, wherein the second communications unit is further configured to establish communications with a Foundation Fieldbus network, a Process Field Bus (PROFIBUS) network, or both.

23. The adaptor device as recited in claim 15, wherein the first communications unit is further configured to establish communications with another wireless network for industrial automation, the another wireless network comprising an ISA100 network, a Wireless Networks for Industrial Automation-Process Automation (WIA-PA) network, or a combination thereof.
